(19) United States
(12) Patent Application Publication
(10) Pub. No.: US 2026/0030181 A1
(43) Pub. Date: Jan. 29, 2026

(54) SYSTEM AND METHOD FOR FACILITATING DATA REQUEST MANAGEMENT IN A NETWORK INTERFACE CONTROLLER (NIC)

(71) Applicant: Hewlett Packard Enterprise Development LP, Spring, TX (US)

(72) Inventors: Abdulla M. Bataineh, Vista, CA (US); Thomas Court, Three Lakes, WI (US); David Charles Hewson, Bristol (GB); Timothy J. Johnson, Sun Prairie, WI (US)

(21) Appl. No.: 19/347,473

(22) Filed: Oct. 1, 2025

Related U.S. Application Data
(63) Continuation of application No. 17/594,820, now Pat. No. 12,443,546.
(60) Provisional application No. 62/852,203, filed on May 23, 2019.
(60) Provisional application No. 62/852,273, filed on May 23, 2019.
(60) Provisional application No. 62/852,289, filed on May 23, 2019.

(51) Int. Cl. G06F 13/16; G06F 9/50; G06F 9/54; G06F 12/0862; G06F 12/1036; G06F 12/1045; G06F 13/14; G06F 13/28; G06F 13/38; G06F 13/40; G06F 13/42; G06F 15/173; H04L 1/00; H04L 43/0876; H04L 43/10; H04L 45/00; H04L 45/02; H04L 45/021; H04L 45/028; H04L 45/12; H04L 45/122; H04L 45/125; H04L 45/16; H04L 45/24; H04L 45/28; H04L 45/42; H04L 45/745; H04L 45/7453; H04L 47/10; H04L 47/11; H04L 47/12; H04L 47/122; H04L 47/20; H04L 47/22; H04L 47/24; H04L 47/2441; H04L 47/2466; H04L 47/2483; H04L 47/30; H04L 47/32; H04L 47/34; H04L 47/52; H04L 47/62; H04L 47/625; H04L 47/6275; H04L 47/629; H04L 47/76; H04L 47/762; H04L 47/78; H04L 47/80; H04L 49/00; H04L 49/101; H04L 49/15; H04L 49/90; H04L 49/9005; H04L 49/9047; H04L 67/1097; H04L 69/22; H04L 69/28; H04L 69/40

(52) U.S. Cl. CPC G06F 13/1642; G06F 9/505; G06F 9/546; G06F 12/0862; G06F 12/1036; G06F 12/1063; G06F 13/14; G06F 13/16; G06F 13/1673; G06F 13/28; G06F 13/385; G06F 13/4022; G06F 13/4068; G06F 13/4221; G06F 15/17331; H04L 1/0083; H04L 43/0876; H04L 43/10; H04L 45/02; H04L 45/021; H04L 45/028; H04L 45/122; H04L 45/123; H04L 45/125; H04L 45/16; H04L 45/20; H04L 45/22; H04L 45/24; H04L 45/38; H04L 45/42; H04L 45/46; H04L 45/566; H04L 45/70; H04L 45/745; H04L 47/11; H04L 47/12; H04L 47/122; H04L 47/18; H04L 47/20; H04L 47/22; H04L 47/24; H04L 47/2441; H04L 47/2466; H04L 47/2483; H04L 47/30; H04L 47/32; H04L 47/323; H04L 47/34; H04L 47/39; H04L 47/52; H04L 47/621; H04L 47/6235; H04L 47/626; H04L 47/6275; H04L 47/629; H04L 47/76; H04L 47/762; H04L 47/781; H04L 47/80; H04L 49/101; H04L 49/15; H04L 49/30; H04L 49/3009; H04L 49/3018; H04L 49/3027; H04L 49/90; H04L 49/9005; H04L 49/9021; H04L 49/9036; H04L 49/9047; H04L 67/1097; H04L 69/22; H04L 69/40; G06F 13/1689; G06F 2212/50; G06F 2213/0026; G06F 2213/3808; H04L 45/28; H04L 45/7453; H04L 69/28

(57) ABSTRACT

A network interface controller (NIC) capable of facilitating efficient data request management is provided. The NIC can be equipped with a command queue, a message chopping unit (MCU), and a traffic management logic block. During operation, the command queue can store a command issued via a host interface. The MCU can then determine a type of the command and a length of a response of the command. If the command is a data request, the traffic management logic block can determine whether the length of the response is within a threshold. If the length exceeds the threshold, the traffic management logic block can pace the command such that the response is within the threshold.

### CROSS REFERENCE TO RELATED APPLICATIONS

This application is a continuation of U.S. patent application Ser. No. 17/594,820, filed on Oct. 29, 2021, which application is a national stage of International Application No. PCT/US2020/024254, filed on Mar. 23, 2020, which claims the benefit of U.S. Provisional Application No. 62/852,203 filed on May 23, 2019, U.S. Provisional Application No. 62/852,273 filed on May 23, 2019 and U.S. Provisional Application No. 62/852,289 filed May 23, 2019. The disclosures of the aforementioned applications are hereby incorporated by reference in their entireties.

### BACKGROUND

### Field

This is generally related to the technical field of networking. More specifically, this disclosure is related to systems and methods for facilitating a network interface controller (NIC) with efficient data request management.

### Related Art

As network-enabled devices and applications become progressively more ubiquitous, various types of traffic as well as the ever-increasing network load continue to demand more performance from the underlying network architecture. For example, applications such as high-performance computing (HPC), media streaming, and Internet of Things (IOT) can generate different types of traffic with distinctive characteristics. As a result, in addition to conventional network performance metrics such as bandwidth and delay, network architects continue to face challenges such as scalability, versatility, and efficiency.

### SUMMARY

A network interface controller (NIC) capable of facilitating efficient data request management is provided. The NIC can be equipped with a command queue, a message chopping unit (MCU), and a traffic management logic block. During operation, the command queue can store a command issued via a host interface. The MCU can then determine a type of the command and generate a set of requesting packets from the command. For a respective requesting packet, the MCU can determine a length of a response (e.g., a response packet) of the requesting packet. If the command is a data request, the traffic management logic block can determine whether the length of the response is within a threshold. If the length exceeds the threshold, the traffic management logic block can pace the command such that the response is within the threshold.

### BRIEF DESCRIPTION OF THE FIGURES

FIG. 1 shows an exemplary network.

FIG. 2A shows an exemplary NIC chip with a plurality of NICs.

FIG. 2B shows an exemplary architecture of a NIC.

FIG. 3 shows exemplary efficient data request management in a NIC.

FIG. 4A shows a flow chart of an exemplary data request throttling process in a NIC.

FIG. 4B shows a flow chart of an exemplary arbitration process for facilitating data request throttling in a NIC.

FIG. 5 shows an exemplary computer system equipped with a NIC that facilitates efficient data request management.

In the figures, like reference numerals refer to the same figure elements.

### DETAILED DESCRIPTION

Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown.

### Overview

The present disclosure describes systems and methods that facilitate efficient data request management in a network interface controller (NIC). The NIC allows a host to communicate with a data-driven network.

The embodiments described herein solve the problem of network congestion caused by disparity in respective sizes of data requests and responses by (i) identifying a data request in a NIC and determining the size of a corresponding response, and (ii) throttling the rate of requests at the NIC, if needed, to limit the rate of corresponding responses within a threshold.

During operation, a user process, which may run on an initiator computing device, can generate a data request (e.g., a “GET” command of remote direct memory access (RDMA)) and insert the request into a command queue of the NIC. The process can notify the NIC regarding the insertion, for example, by updating a write pointer. The NIC can fetch the request and initiate forwarding of the request (e.g., in a message or packet). However, the NIC may process and forward requests at a rate that is higher than the rate at which corresponding responses are returned. For example, a request can be relatively small in size (e.g., 48 bytes long) while the corresponding response can be significantly larger in size (e.g., 2048 bytes long).

As a result, the request may require 1 clock cycle of the NIC to issue but the response message may require 50 clock cycles of the NIC to write the response data into the memory of the host device of the NIC. Consequently, there may be a 1:50 disparity in the sizes and processing time between the request and the corresponding response. If the NIC continues to issue a request in every clock cycle, when the responses come back, due to their significantly larger size, there can be congestion in the network. In particular, if the NIC continues to receive a large quantity of data, the corresponding backpressure can lead to significant congestion in the network. The larger the responses, the more congested the input queues can become.

To solve this problem, the NIC can be equipped with a request management system that can inspect a respective command obtained from the command queue to determine whether the command is a data request. If the command is a data request (e.g., a GET command), the NIC can determine the size of the corresponding response based on the quantity of data requested. The NIC can then determine the potential incoming data rate that can be generated by the response. Subsequently, the NIC determines whether the potential incoming data rate is within a threshold. In some embodiments, the threshold can be set based on the rate at which the NIC can absorb the responses. In this way, the rate at which requests are allowed to be issued is controlled by the NIC so that the rate matches the bandwidth at which the NIC can absorb the responses.

One embodiment of the present invention provides NIC. The NIC can be equipped with a command queue, a message chopping unit (MCU), and a traffic management logic block. During operation, the command queue stores a command issued via a host interface. The MCU can then determine a type of the command and generate a set of requesting packets from the command. For a respective requesting packet, the MCU can determine a length of a response (e.g., a response packet) of the requesting packet. If the command is a data request, the traffic management logic block determines whether the length of the response is within a threshold. If the length exceeds the threshold, the traffic management logic block paces the command such that the response is within the threshold.

In a variation on this embodiment, the data request can be a remote direct memory access (RDMA) GET command.

In a variation on this embodiment, the MCU can divide the data request into a sequence of sub-requests and include a respective sub-request in a requesting packet. The traffic shaping logic block can then individually manage a respective sub-request.

In a variation on this embodiment, the MCU can generate a packet associated with the command. The NIC can also include a network interface that forwards the packet to a switch fabric.

In a variation on this embodiment, the MCU can be one of a plurality of MCUs residing on the NIC. The traffic management logic block can then arbitrate among the plurality of MCUs to select the MCU for forwarding the command.

In a further variation, the traffic management logic block can pace the command by selecting a second MCU of the plurality of MCUs for forwarding a second command and selecting the MCU for forwarding the command in response to the length of the response of the command falling within the threshold.

In a further variation, the NIC can also include a plurality of flow queues. A respective flow queue can correspond to a unique flow in the NIC. Furthermore, a respective flow queue can be assigned to an MCU of the plurality of MCUs.

In a variation on this embodiment, the threshold can correspond to a rate at which the NIC is capable of processing responses. In this way, the NIC can issue commands at a rate that matches the rate at which the NIC is capable of processing the responses.

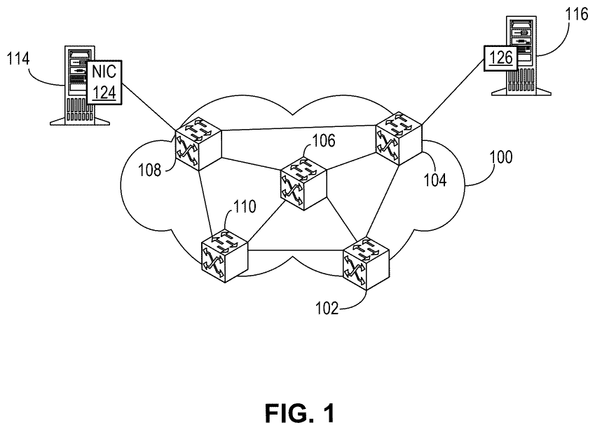

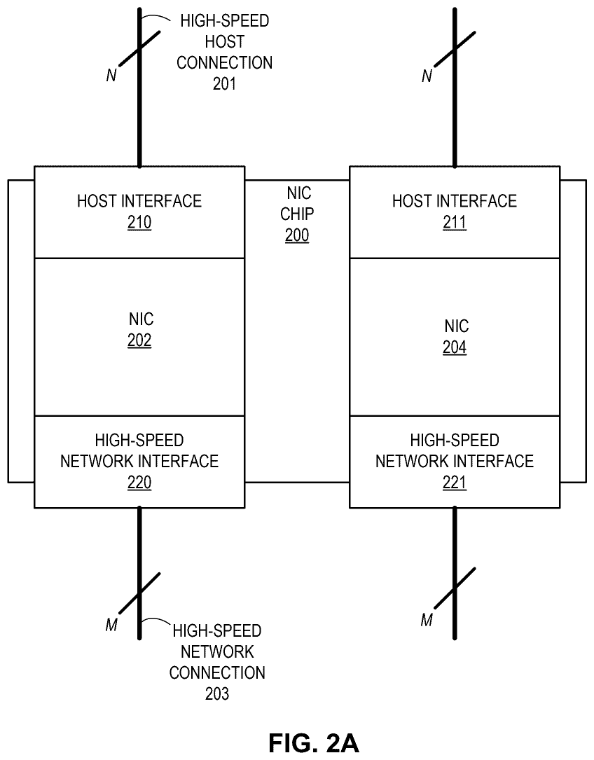

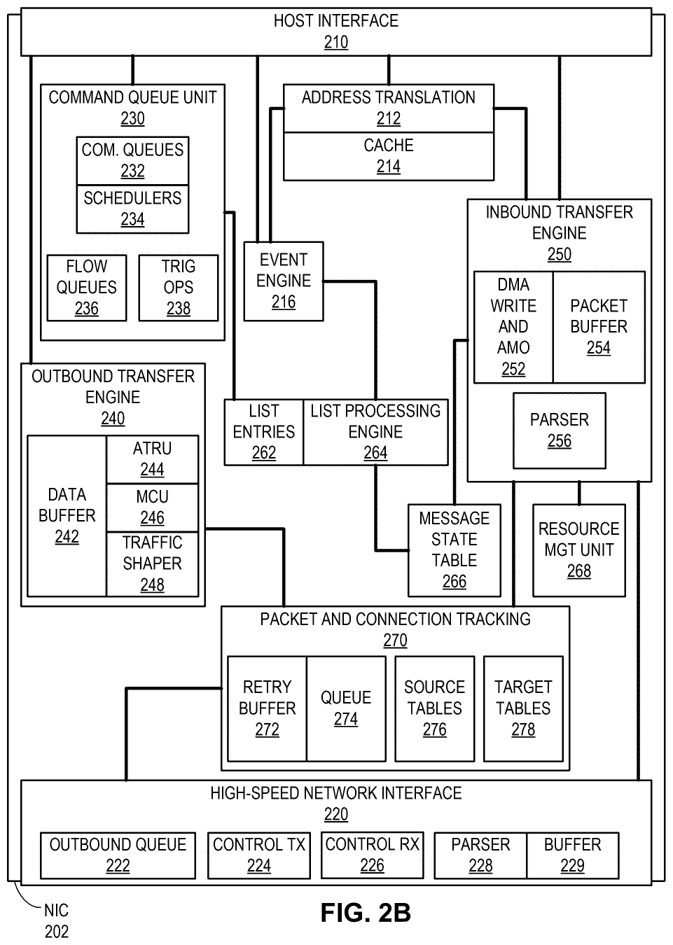

In this disclosure, the description in conjunction with FIG. 1 is associated with the network architecture and the description in conjunction with FIG. 2A and onward provide more details on the architecture and operations associated with a NIC that supports efficient data request management.

In this disclosure, packet streams can also be referred to as “packet flows,” or simply “flows.” The data path traversed by a flow, together with its configuration information maintained by switches, can be referred to as a “flow channel.” Furthermore, the terms “buffer” and “queue” are used interchangeably in this disclosure.

FIG. 1 shows an exemplary network that facilitates flow channels. In this example, a network 100 of switches, which can also be referred to as a “switch fabric,” can include switches 102, 104, 106, 108, and 110. Host devices 114 and 116 can be equipped with NICs 124 and 126, respectively. If host device 114 issues a command and host device 116 is the target of the command, NICs 124 and 126 can be referred to as the source and target NICs, respectively.

### Exemplary NIC Architecture

FIG. 2A shows an exemplary NIC chip with a plurality of NICs. With reference to the example in FIG. 1, a NIC chip 200 can be a custom application-specific integrated circuit (ASIC) designed for host 116 to work with switch fabric 100. In this example, chip 200 can provide two independent NICs 202 and 204. A respective NIC of chip 200 can be equipped with a host interface (HI) (e.g., an interface for connecting to the host processor) and one High-speed Network Interface (HNI) for communicating with a link coupled to switch fabric 100 of FIG. 1. For example, NIC 202 can include an HI 210 and an HNI 220, and NIC 204 can include an HI 211 and an HNI 221.

In some embodiments, HI 210 can be a peripheral component interconnect (PCI) or a peripheral component interconnect express (PCIe) interface. HI 210 can be coupled to a host via a host connection 201, which can include N (e.g., N can be 16 in some chips) PCIe Gen 4 lanes capable of operating at signaling rates up to 25 Gbps per lane. HNI 210 can facilitate a high-speed network connection 203, which can communicate with a link in switch fabric 100 of FIG. 1. HNI 210 can operate at aggregate rates of either 100 Gbps or 200 Gbps using M (e.g., M can be 4 in some chips) full-duplex serial lanes. Each of the M lanes can operate at 25 Gbps or 50 Gbps based on non-return-to-zero (NRZ) modulation or pulse amplitude modulation 4 (PAM4), respectively. HNI 220 can support the Institute of Electrical and Electronics Engineers (IEEE) 802.3 Ethernet-based protocols as well as an enhanced frame format that provides support for higher rates of small messages.

NIC 202 can support one or more of: point-to-point message passing based on Message Passing Interface (MPI), remote memory access (RMA) operations, offloading and progression of bulk data collective operations, and Ethernet packet processing. When the host issues an MPI message, NIC 202 can match the corresponding message type. Furthermore, NIC 202 can implement both cager protocol and rendezvous protocol for MPI, thereby offloading the corresponding operations from the host.

Furthermore, the RMA operations supported by NIC 202 can include PUT, GET, and Atomic Memory Operations (AMO). NIC 202 can provide reliable transport. For example, if NIC 202 is a source NIC, NIC 202 can provide a retry mechanism for idempotent operations. Furthermore, connection-based error detection and retry mechanism can be used for ordered operations that may manipulate a target state. The hardware of NIC 202 can maintain the state necessary for the retry mechanism. In this way, NIC 202 can remove the burden from the host (e.g., the software). The policy that dictates the retry mechanism can be specified by the host via the driver software, thereby ensuring flexibility in NIC 202.

Furthermore, NIC 202 can facilitate triggered operations, a general-purpose mechanism for offloading, and progression of dependent sequences of operations, such as bulk data collectives. NIC 202 can support an application programming interface (API) (e.g., libfabric API) that facilitates fabric communication services provided by switch fabric 100 of FIG. 1 to applications running on host 116. NIC 202 can also support a low-level network programming interface, such as Portals API. In addition, NIC 202 can provide efficient Ethernet packet processing, which can include efficient transmission if NIC 202 is a sender, flow steering if NIC 202 is a target, and checksum computation. Moreover, NIC 202 can support virtualization (e.g., using containers or virtual machines).

FIG. 2B shows an exemplary architecture of a NIC. In NIC 202, the port macro of HNI 220 can facilitate low-level Ethernet operations, such as physical coding sublayer (PCS) and media access control (MAC). In addition, NIC 202 can provide support for link layer retry (LLR). Incoming packets can be parsed by parser 228 and stored in buffer 229. Buffer 229 can be a PFC Buffer provisioned to buffer a threshold amount (e.g., one microsecond) of delay bandwidth. HNI 220 can also include control transmission unit 224 and control reception unit 226 for managing outgoing and incoming packets, respectively.

NIC 202 can include a Command Queue (CQ) unit 230. CQ unit 230 can be responsible for fetching and issuing host side commands. CQ unit 230 can include command queues 232 and schedulers 234. Command queues 232 can include two independent sets of queues for initiator commands (PUT, GET, etc.) and target commands (Append, Search, etc.), respectively. Command queues 232 can be implemented as circular buffers maintained in the memory of NIC 202. Applications running on the host can write to command queues 232 directly. Schedulers 234 can include two separate schedulers for initiator commands and target commands, respectively. The initiator commands are sorted into flow queues 236 based on a hash function. One of flow queues 236 can be allocated to a unique flow. Furthermore, CQ unit 230 can further include a triggered operations module (or logic block) 238, which is responsible for queuing and dispatching triggered commands.

Outbound transfer engine (OXE) 240 can pull commands from flow queues 236 in order to process them for dispatch. OXE 240 can include an address translation request unit (ATRU) 244 that can send address translation requests to address translation unit (ATU) 212. ATU 212 can provide virtual to physical address translation on behalf of different engines, such as OXE 240, inbound transfer engine (IXE) 250, and event engine (EE) 216. ATU 212 can maintain a large translation cache 214. ATU 212 can either perform translation itself or may use host-based address translation services (ATS). OXE 240 can also include message chopping unit (MCU) 246, which can fragment a large message into packets of sizes corresponding to a maximum transmission unit (MTU). MCU 246 can include a plurality of MCU modules. When an MCU module becomes available, the MCU module can obtain the next command from an assigned flow queue. The received data can be written into data buffer 242. The MCU module can then send the packet header, the corresponding traffic class, and the packet size to traffic shaper 248. Shaper 248 can determine which requests presented by MCU 246 can proceed to the network.

Subsequently, the selected packet can be sent to packet and connection tracking (PCT) 270. PCT 270 can store the packet in a queue 274. PCT 270 can also maintain state information for outbound commands and update the state information as responses are returned. PCT 270 can also maintain packet state information (e.g., allowing responses to be matched to requests), message state information (e.g., tracking the progress of multi-packet messages), initiator completion state information, and retry state information (e.g., maintaining the information required to retry a command if a request or response is lost). If a response is not returned within a threshold time, the corresponding command can be stored in retry buffer 272. PCT 270 can facilitate connection management for initiator and target commands based on source tables 276 and target tables 278, respectively. For example, PCT 270 can update its source tables 276 to track the necessary state for reliable delivery of the packet and message completion notification. PCT 270 can forward outgoing packets to HNI 220, which stores the packets in outbound queue 222.

NIC 202 can also include an IXE 250, which provides packet processing if NIC 202 is a target or a destination. IXE 250 can obtain the incoming packets from HNI 220. Parser 256 can parse the incoming packets and pass the corresponding packet information to a List Processing Engine (LPE) 264 or a Message State Table (MST) 266 for matching. LPE 264 can match incoming messages to buffers. LPE 264 can determine the buffer and start address to be used by each message. LPE 264 can also manage a pool of list entries 262 used to represent buffers and unexpected messages. MST 266 can store matching results and the information required to generate target side completion events. MST 266 can be used by unrestricted operations, including multi-packet PUT commands, and single-packet and multi-packet GET commands.

Subsequently, parser 256 can store the packets in packet buffer 254. IXE 250 can obtain the results of the matching for conflict checking. DMA write and AMO module 252 can then issue updates to the memory generated by write and AMO operations. If a packet includes a command that generates target side memory read operations (e.g., a GET response), the packet can be passed to the OXE 240. NIC 202 can also include an EE 216, which can receive requests to generate event notifications from other modules or units in NIC 202. An event notification can specify that either a fill event or a counting event is generated. EE 216 can manage event queues, located within host processor memory, to which it writes full events. EE 216 can forward counting events to CQ unit 230.

### Request Management in NIC

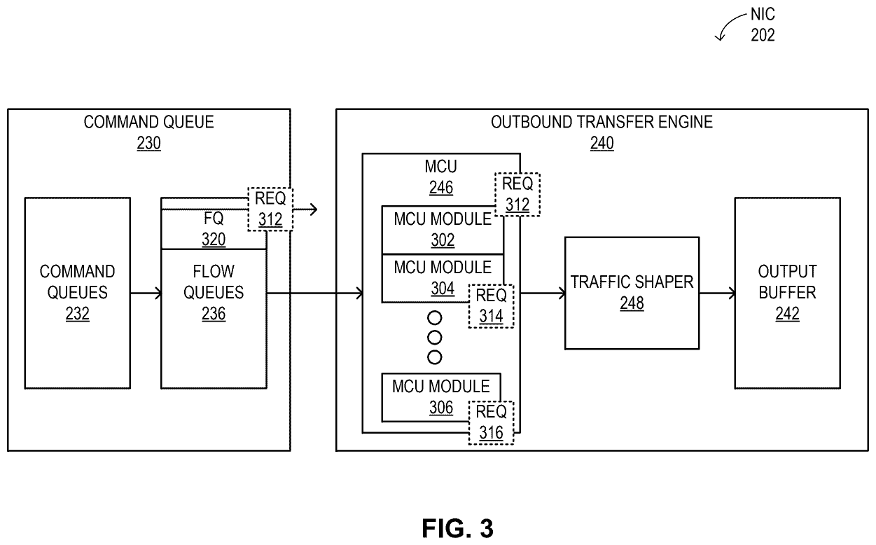

FIG. 3 shows exemplary efficient data request management in a NIC. If the host process generates a data request, such as a GET command, the process can write the request in one of the command queues 232. The process can notify NIC 202 regarding the insertion by updating a write pointer of command queue 232. NIC 202 can fetch the request and initiate forwarding the request. However, NIC 202 may process and forward requests at a rate that is higher than the rate at which corresponding responses are returned. For example, the request may require 1 clock cycle of NIC 202 to issue but the response message may require 50 clock cycles of NIC 202 to obtain the requested data. Consequently, there may be a 1:50 disparity in the sizes and processing time between the request and the corresponding response. If NIC 202 continues to issue a request in every clock cycle, when the responses come back, due to their significantly larger size, there can be congestion.

To solve this problem, OXE 240 can inspect a respective command, such as request 312, obtained from command queues 232 to determine whether request 312 is a data request. In some embodiments, OXE 240 can perform a deep packet inspection (e.g., by inspecting the inner headers within the payload of request 312) to determine the command type of request 312. NIC 202 may also determine the type based on MPI matching. Upon determining that request 312 is a data request, OXE 240 can determine the size of the corresponding response based on the quantity of data requested by request 312. OXE 240 can then determine the potential incoming data rate that can be generated by the response. Subsequently, OXE 240 can determine whether the potential incoming data rate is within a threshold. In some embodiments, the threshold can be set based on the rate at which NIC 202 can absorb or process the responses.

Request 312 can be allocated to a flow queue 320 of flow queues 236 based on a flow associated with request 312. OXE 240 can obtain request 312 from flow queue 320 and provide request 312 to an MCU module 302 (e.g., in MCU 246) that has been assigned to flow queue 320. Similarly, OXE 240 can obtain requests 314 and 316 from respective flow queues and provide the requests 312 to MCU modules 304 and 306, respectively. It should be noted that MCU 246 can include a number of MCU modules, each of which can correspond to a flow queue in flow queues 236.

MCU module 302 can maintain an OrdPktActive count of outstanding packets, such as a packet associated with request 312. MCU module 302 can increment OrdPktActive count when a packet is constructed for a message and decrement the count when MCU module 302 observes a response being processed by PCT 270. MCU module 302 can stall the generation of request packets when the OrdPktActive count exceeds a threshold value defined in a register. The threshold value can indicate the appropriate limit. Since throttling the rate of requests relies on expected response length of a respective request, MCU module 302 can determine a RspPktLen value, which indicates the response packet length, for request 312. MCU module 302 can calculate RspPktLen based on the payload of request 312 (e.g., the amount of data requested).

In some embodiments, traffic shaper 248 can determine from which MCU module in MCU 246 to take the next packet to send. Traffic shaper 248 can select an MCU module based on the priority flow control from the link partner, bandwidth sharing between different traffic shaping classes, and bandwidth sharing between MCU modules within a class. By arbitrating among the MCU modules, traffic shaper 248 can throttle (or pace) request packets to match the expected rate of corresponding responses. In this way, traffic shaper 248 can manage the outbound and inbound bandwidth utilized by the applications running on the host. Since an application can perform bulk data transfer using a combination of data transfer (e.g., a PUT command) and data requests (e.g., a GET command), traffic shaper 248 can categorize PUT requests and GET responses as consuming bandwidth for outbound packets and can assign the sum of these to a bandwidth policy.

In this example, traffic shaper 248 can obtain respective OrdPktActive and RspPktLen of requests 312, 314, and 316 from MCU modules 302, 304, and 306, respectively. Traffic shaper 248 may determine that the response for request 312 is within the threshold. Accordingly, traffic shaper 248 can select MCU module 302 based on the arbitration, obtain request 312, and place request 312 in output buffer 242 for forwarding. However, traffic shaper 248 may determine that the response for request 314 can exceed the threshold. Accordingly, traffic shaper 248 can skip MCU module 304 based on the arbitration, thereby refraining from selecting MCU module 304 for forwarding.

Subsequently, traffic shaper 248 may determine that the response for request 316 is within the threshold. Traffic shaper 248 can then select MCU module 306 based on the arbitration, obtain request 316, and place request 316 in output buffer 242. Traffic shaper 248 may select MCU module 304 for forwarding request 314 when the length of the response for request 314 falls within the threshold based on the arbitration process. In this way, MCU modules 302, 304, and 306 can process the requests, such as GET commands, and traffic shaper 248 paces MCU modules 302, 304, and 306 arbitrating among them. Since MCU modules provide the requests, by pacing the MCU modules, traffic shaper 248 can pace the requests.

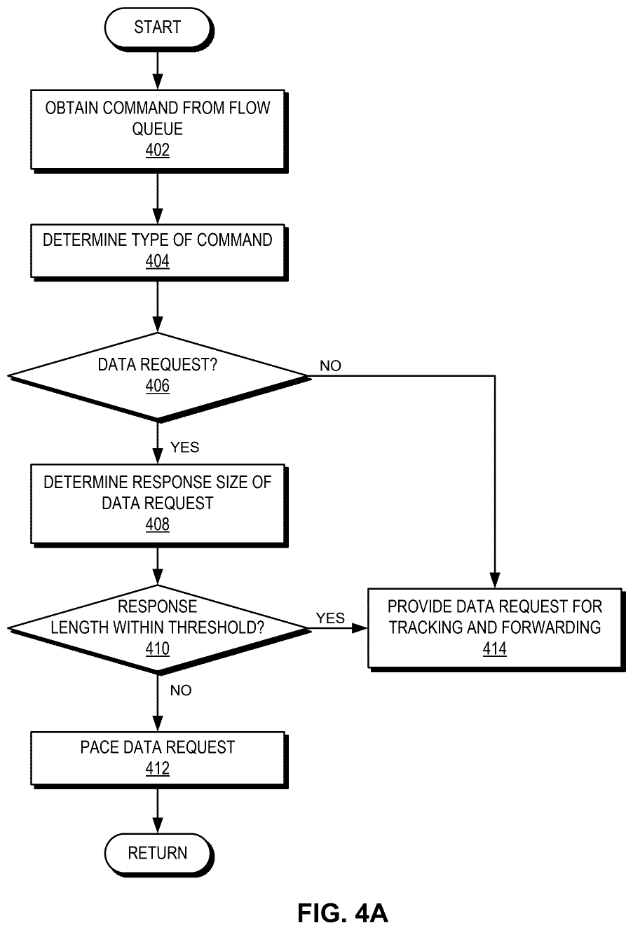

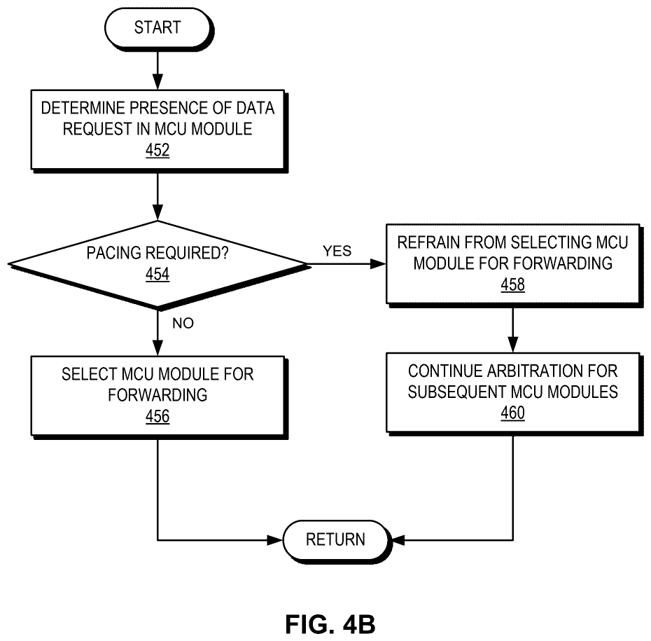

FIG. 4A shows a flow chart of an exemplary data request throttling process in a NIC. During operation, an OXE of the NIC can obtain a command from a flow queue (operation 402). The OXE can then determine the type of the command (operation 404) and check whether the command is a data request (e.g. GET command) operation 406). Subsequently, the OXE can determine a response size of the data request (operation 408) and determine whether a response length of the data request is within a threshold (operation 410). In some embodiments, an MCU module in the OXE can calculate RspPktLen for the command and provide RspPktLen to a packet shaper, which, in turn, can determine whether the response length is within a threshold. If the response length is within the threshold, the OXE can pace the data request (e.g., by throttling the transmission rate of data requests) (operation 412). On the other hand, if the response length is within the threshold, the OXE can provide the data request for tracking and forwarding (operation 414).

FIG. 4B shows a flow chart of an exemplary arbitration process for facilitating data request throttling in a NIC. During operation, a traffic shaper of the NIC determines the presence of a data request in an MCU module (operation 452). In some embodiments, the MCU module can provide information, such as RspPktLen, associated with the data request to the traffic shaper, thereby notifying the traffic shaper regarding the presence of the data request. The traffic shaper can then determine whether pacing is required for the data request based on the response length (operation 454). If pacing is not required, the traffic shaper can select the MCU module for forwarding (operation 456). However, if pacing is required for the data request, the traffic shaper can refrain from selecting the MCU module for forwarding (operation 458) and continue arbitration for subsequent MCU modules (operation 460). A subsequent MCU module can be selected based on an arbitration policy of the NIC. Examples of an arbitration policy include, but are not limited to, round robin selection, load-based selection, priority-based selection, and availability-based selection.

### Exemplary Computing Device

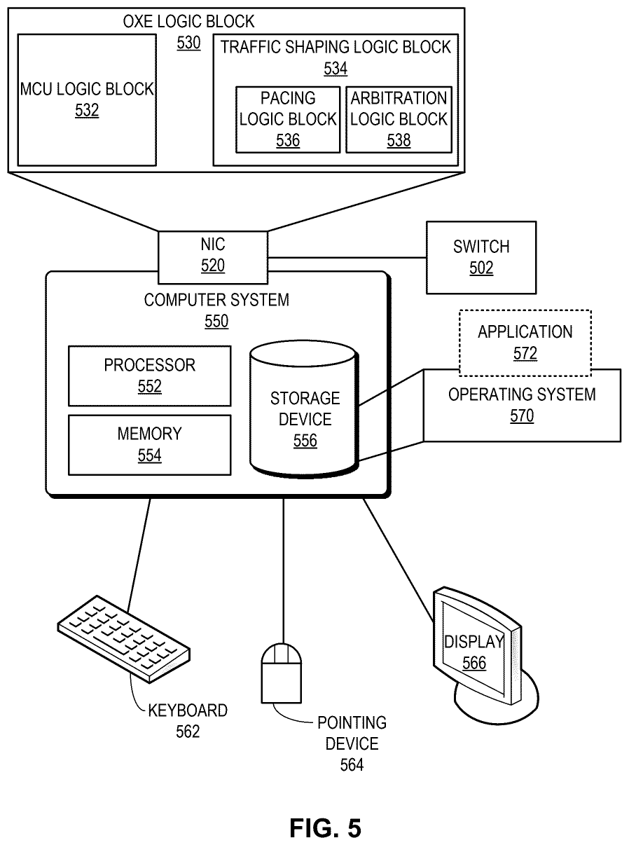

FIG. 5 shows an exemplary computer system equipped with a NIC that facilitates efficient data request management. Computer system 550 includes a processor 552, a memory device 554, and a storage device 556. Memory device 554 can include a volatile memory device (e.g., a dual in-line memory module (DIMM)). Furthermore, computer system 550 can be coupled to a keyboard 562, a pointing device 564, and a display device 566. Storage device 556 can store an operating system 570. An application 572 can operate on operating system 570.

Computer system 550 can be equipped with a host interface coupling a NIC 520 that facilitates efficient data request management. NIC 520 can provide one or more HNIs to computer system 550. NIC 520 can be coupled to a switch 502 via one of the HNIs. NIC 520 can include an OXE logic block 530, as described in conjunction with FIG. 2B. OXE logic block 530 can include an MCU logic block 532 that can obtain a command, such as a GET or a PUT command. The command can be issued by application 572 via the host interface. MCU logic block 532 can determine a type of the command and a length of a response of the command. MCU logic block 532 can provide these pieces of information to a traffic shaping logic block 534 of OXE logic block 530. Traffic shaping logic block 534 can further include a pacing logic block 536 and an arbitration logic block 538. Pacing logic block 536 can determine whether the command requires pacing based on the type of the command and the length of the response of the command. Arbitration logic block 538 can arbitrate among a set of MCUs of MCU logic block 532. If the command requires pacing, arbitration logic block 538 may refrain from selecting the corresponding MCU, thereby pacing the data requests in NIC 520.

In summary, the present disclosure describes a NIC that facilitates efficient data request management. The NIC can reside in a computer system that can also include a processor, a memory device, and a host interface configured to couple the NIC. The NIC can be equipped with a command queue, an MCU, and a traffic management logic block. During operation, the command queue stores a command issued via the host interface. The MCU can then determine a type of the command and a length of a response of the command. If the command is a data request, the traffic management logic block determines whether the length of the response is within a threshold. If the length exceeding the threshold, the traffic management logic block paces the command such that the response is within the threshold.

The methods and processes described above can be performed by hardware logic blocks, modules, logic blocks, or apparatus. The hardware logic blocks, modules, or apparatus can include, but are not limited to, application-specific integrated circuit (ASIC) chips, field-programmable gate arrays (FPGAs), dedicated or shared processors that execute a piece of code at a particular time, and other programmable-logic devices now known or later developed. When the hardware logic blocks, modules, or apparatus are activated, they perform the methods and processes included within them.

The methods and processes described herein can also be embodied as code or data, which can be stored in a storage device or computer-readable storage medium. When a processor reads and executes the stored code or data, the processor can perform these methods and processes.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A network interface controller (NIC), comprising:
a command queue to store a command issued via a host interface;
a message chopping unit (MCU) to determine a type of the command and a length of a response of the command; and
a traffic shaping logic block to:
in response to the command being a data request, determine whether the length of the response is within a threshold; and
in response to the length exceeding the threshold, pace the command such that the response is within the threshold.

2. The network interface controller of claim 1, wherein the data request is a remote direct memory access (RDMA) GET command.

3. The network interface controller of claim 1, wherein the MCU is further to:
divide the data request into a sequence of sub-requests; and
include a respective sub-request in a requesting packet; and
wherein the traffic shaping logic block is further to individually manage a respective sub-request.

4. The network interface controller of claim 1, wherein the MCU is further to generate a packet associated with the command; and
wherein the network interface controller further comprises a network interface to forward the packet to a switch fabric.

5. The network interface controller of claim 1, wherein the MCU is one of a plurality of MCUs residing on the network interface controller; and
wherein the traffic shaping logic block is further to arbitrate among the plurality of MCUs to select the MCU for forwarding the command.

6. The network interface controller of claim 5, wherein the traffic shaping logic block is to pace the command by:
selecting a second MCU of the plurality of MCUs for forwarding a second command;
and
selecting the MCU for forwarding the command in response to the length of the response of the command falling within the threshold.

7. The network interface controller of claim 5, wherein the NIC further comprises a plurality of flow queues, wherein a respective flow queue corresponds to a unique flow in the network interface controller; and
wherein a respective flow queue is assigned to an MCU of the plurality of MCUs.

8. The network interface controller of claim 1, wherein the threshold corresponds to a rate at which the network interface controller is capable of processing responses, thereby issuing commands at a rate that matches the rate at which the network interface controller is capable of processing responses.

9. A method, comprising:
storing, in a command queue of a network interface controller (NIC), a command issued via a host interface that couples the network interface controller to a host device;
determining, by the network interface controller, a type of the command and a length of a response of the command;
in response to the command being a data request, determining whether the length of the response is within a threshold; and
in response to the length exceeding the threshold, pacing the command such that the response is within the threshold.

10. The method of claim 9, wherein the data request is a remote direct memory access (RDMA) GET command.

11. The method of claim 9, further comprising:
dividing the data request into a sequence of sub-requests;
including a respective sub-request in a requesting packet; and
individually managing a respective sub-request.

12. The method of claim 9, further comprising:
generating a packet associated with the command; and
forwarding the packet to a switch fabric.

13. The method of claim 9, wherein the network interface controller comprises a plurality of message chopping units (MCUs); and
wherein the method further comprises arbitrating among the plurality of MCUs to select an MCU for forwarding the command.

14. The method of claim 13, wherein pacing the command further comprises:
selecting a second MCU of the plurality of MCUs for forwarding a second command; and
selecting the MCU for forwarding the command in response to the length of the response of the command falling within the threshold.

15. The method of claim 13, wherein the network interface controller further comprises a plurality of flow queues, wherein a respective flow queue corresponds to a unique flow in the network interface controller; and
wherein a respective flow queue is assigned to an MCU of the plurality of MCUs.

16. The method of claim 9, wherein the threshold corresponds to a rate at which the network interface controller is capable of processing responses, thereby issuing commands at a rate that matches the rate at which the network interface controller is capable of processing responses.

17. A computer system, comprising:
a processor;
a network interface controller (NIC); and
a host interface to couple the NIC;
wherein the NIC comprises:
a command queue to store a command issued via the host interface;
a message chopping unit (MCU) to determine a type of the command and a length of a response of the command; and
a traffic shaping logic block to:
in response to the command being a data request, determine whether the length of the response is within a threshold; and
in response to the length exceeding the threshold, pace the command such that the response is within the threshold.

18. The computer system of claim 17, wherein the MCU is further to:
divide the data request into a sequence of sub-requests; and
include a respective sub-request in a requesting packet; and
wherein the traffic shaping logic block is further to individually manage a respective sub-request.

19. The computer system of claim 17, wherein the MCU is one of a plurality of MCUs residing on the network interface controller; and
wherein the traffic shaping logic block is further to arbitrate among the plurality of MCUs to select the MCU for forwarding the command.

20. The computer system of claim 19, wherein the traffic shaping logic block is to pace the command by:
selecting a second MCU of the plurality of MCUs for forwarding a second command; and
selecting the MCU for forwarding the command in response to the length of the response of the command falling within the threshold.
